(19) United States
(12) Patent Application Publication
(10) Pub. No.: US 2017/0239867 A1
(43) Pub. Date: Aug. 24, 2017

(54) PRESSURE CHAMBER FOR BLOWN FILM EXTRUSION

(71) Applicant: BRAMPTON ENGINEERING INC., Brampton (CA)

(72) Inventor: William WYBENGA, Picton (CA)

(73) Assignee: BRAMPTON ENGINEERING INC., Brampton (CA)

(21) Appl. No.: 15/309,925

(22) PCT Filed: May 13, 2015
(86) PCT No.: PCT/CA2015/000305

§ 371 Date: Nov. 9, 2016

Related U.S. Application Data
(60) Provisional application No. 61/992,529, filed on May 13, 2014.

(51) Int. Cl. B29C 47/00; B29C 47/90; B29C 47/88; B29C 47/92; B29C 47/08

(52) U.S. Cl. CPC B29C 47/009; B29C 47/92; B29C 47/0057; B29C 47/0021; B29C 47/0026; B29C 47/0867; B29C 47/8835; B29C 47/903; B29C 47/908; B29C 2791/007; B29C 2947/92019; B29C 2947/92123; B29C 2947/92428; B29C 2947/92514; B29C 2947/92619; B29C 2947/92923

(57) ABSTRACT

A pressure chamber is provided for a blown film extrusion apparatus having (i) a die head for extruding a tubular polymer bubble, and (ii) a cooling assembly down-stream of the die head for receiving the bubble and applying a cooling fluid to the bubble. The pressure chamber includes an upstream end wall sealed around the die head outlet, and extending outward from the seal; a side wall movable between a closed position for controlling air flow from a chamber volume surrounding the bubble to the atmosphere, and an open position for permitting air flow from the chamber volume to the atmosphere. The upstream end wall has an inlet for receiving air from an air supply, and an outlet in fluid communication with the inlet and configured to direct the air into the chamber volume to pressurize the chamber volume when the side wall is in the closed position.

### CROSS-REFERENCE TO RELATED APPLICATION

This application claims priority to U.S. provisional patent application No. 61/992529, filed May 13, 2014, the contents of which is hereby incorporated by reference.

### FIELD

The specification relates generally to blown film extrusion of plastic materials, and specifically to a pressure chamber for blown film extrusion.

### BACKGROUND

Coextrusion blown film production lines generally heat and extrude polymer from a die head, and inflate the extrudate into a bubble. The extrudate is blown and drawn down to a thinner melt before being frozen as film. In order to increase the production rate of the lines, the rate at which polymer is extruded from the die head is increased, and thus the temperature of the melt is generally greater than at lower production rates, as the extrudate has less time to cool before being blown and drawn). In addition, higher extrusion rates can make the resulting film more prone to wrinkles further downstream. Increasing production rate while minimizing negative effects on film quality is therefore difficult.

GB 1152564 to J,P, Bemberg Aktiengesellschaft teaches a downward path extrusion blown film machine having a pressure chamber that encloses the bubble between the die head and an annular air cooling venting ring mounted above an annular water cooling jacket that also surrounds the bubble.

GB 1092635 to Samways teaches and upward path extrusion blown film machine having an annular receptacle mounted immediately above the die head which contains a metal alloy having a lower melting temperature than the polymer being processed into film. The air pressure within the bubble is counteracted by the fluid pressure of the metal alloy that surrounds the bubble as it exits the die head and pressure differential is established that is used to control the bubble size.

JPS 6194740A to Asahi Chemical Ind. teaches and upward path extrusion blown film machine having an annular chamber that is mounted above the die head and surrounding the bubble through which cooling air is circulated.

JPS 5939524A to Showa Denko K.K. teaches and upward path extrusion blown film machine having an annular chamber that is mounted above the die head and surrounding the bubble through which cooling air is circulated.

### SUMMARY

A blown film extrusion machine has a pressure chamber enclosing the bubble between the die head and the frost line of the bubble such that the difference between the inflation pressure within the bubble and the air pressure within the pressure chamber is maintained at a constant difference for various extrusion variables, including throughput rates. In order to increase throughput, the pressure within the bubble can be increased to reduce the incidence of wrinkles downstream; the pressure chamber permits pressure around the bubble to be adjusted to accommodate the increased pressure within the bubble and maintain consistent film properties.

### BRIEF DESCRIPTIONS OF THE DRAWINGS

Embodiments are described with reference to the following figures, in which:

FIG. 1 is a cross-sectional side view of a downward path blown film extrusion line machine, according to a non-limiting embodiment;

FIG. 2 depicts a partial cross-sectional side view through the pressure chamber of FIG. 1, according to a non-limiting embodiment;

FIG. 3 depicts the pressure chamber of FIG. 2 in an open position, according to a non-limiting embodiment;

FIG. 4 depicts a partial cross-sectional side view of a pressure chamber for the machine of FIG. 1, according to another non-limiting embodiment;

FIG. 5 depicts the pressure chamber of FIG. 4 in an open position, according to a non-limiting embodiment;

FIG. 6 depicts a partial cross-sectional side view of a pressure chamber, according to a further non-limiting embodiment; and

FIG. 7 depicts a partial cross-sectional side view of a pressure chamber, according to a still further non-limiting embodiment.

### DETAILED DESCRIPTION OF THE EMBODIMENTS

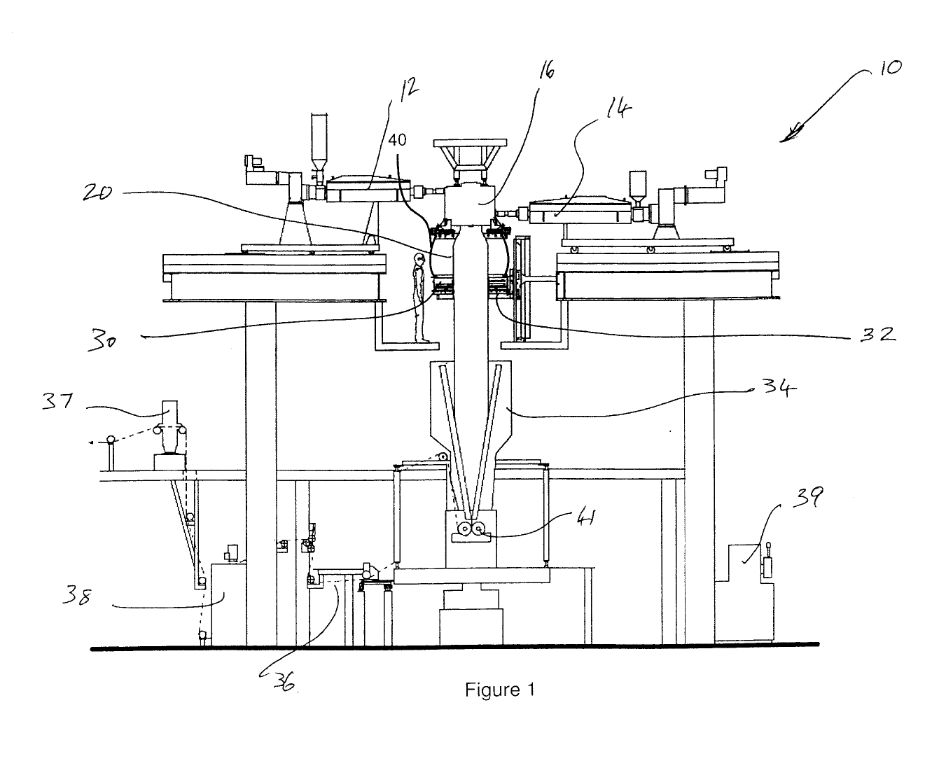

FIG. 1 shows a schematic side view of a downward path extrusion blown film machine 10, including one or more extruders, of which two example extruders 12 and 14 are shown, that feed melted polymer to an extrusion die head 16, from which the polymer is downwardly extruded and internally inflated by air pressure to form a bubble 20 of film. Below the die head 16, bubble 20 is surrounded by a cooling assembly 30. Cooling assembly 30, also referred to herein as ring assembly 30, cools bubble 20 and also establishes an external diameter of bubble 20. Ring assembly 30 is mounted on a frame 32, and can be vertically adjustable on frame 32 to control the distance between ring assembly 30 and die head 16 (that is, to control the point along bubble 20 at which bubble 20 is frozen, fixing the external diameter of bubble 20). The nature of cooling assembly 30 is not particularly limited. In the present example, cooling assembly 30 includes an annular channel (“AquaChamber”) that is supplied with a cooling fluid (such as water) by cooling fluid unit 39. In other embodiments, other cooling fluids can be employed, and cooling assembly 30 can be an air-cooling assembly rather than a fluid-based cooling assembly.

Below ring assembly 30, is a collapsing frame 34, that includes nip rollers 41 that both pull bubble 20 along its downward path and cause bubble 20 to be folded into a flat double thickness film 36, that passes through an optional film annealing station 38. Following film annealing station 38, film 36 can pass through a web guide 37 that measures the layflat width of film 36. Thereafter the film 36 can pass into a film winding unit (not shown) that winds film 36 onto a finishing roll (not shown). Between die head 16 and ring assembly 30, and enclosing bubble 20, is a pressure chamber 40, which is described below in greater detail.

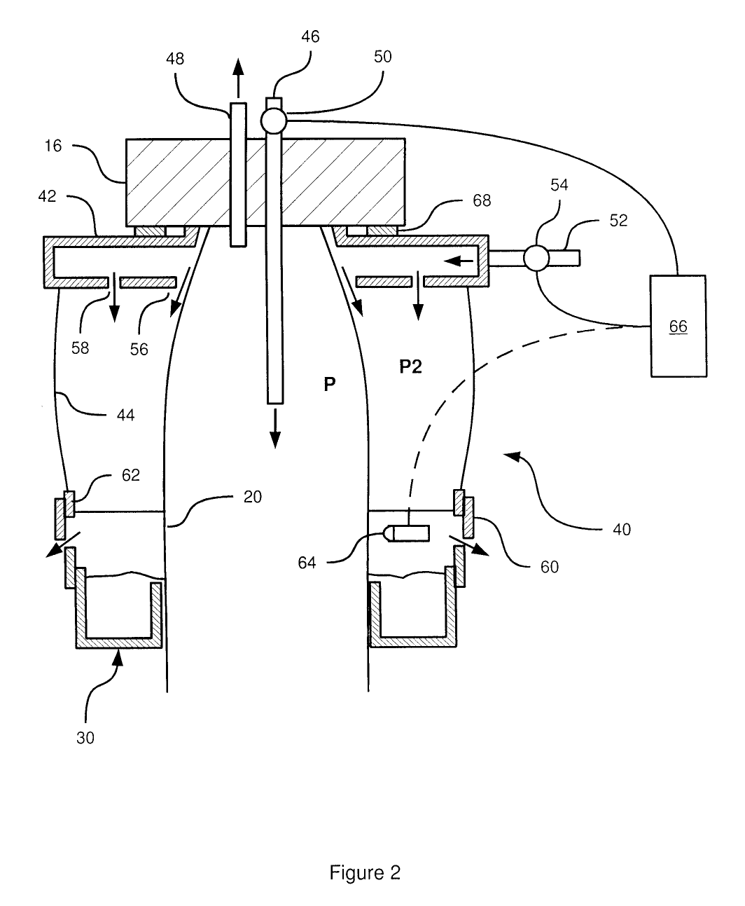

FIG. 2 is a partial cross section illustrating pressure chamber 40 in greater detail. As seen in FIG. 2, pressure chamber 40 comprises an upstream (that is, closer to die head 16) end wall in the form of an air cooling ring 42, mounted around the outlet of die head 16 from which bubble 20 is extruded. Air cooling ring 42 can have the shape of a disc with an opening through the center thereof to allow bubble 20 to pass. Air cooling ring 42 can be sealed to die head 16, for example by an annular seal 68 (e.g. an O-ring). In other embodiments, air cooling ring 42 can be sealed to die head by other mechanisms, such as a weld. As seen in FIG. 2, air cooling ring 42 extends outward (that is, away from the center of bubble 20) from seal 68.

A downstream (that is, further from die head 16) end of pressure chamber 40 is defined by cooling assembly 30, and more specifically in the present embodiment by the surface of cooling fluid contained in assembly 30. Any other surface of assembly 30 may form the downstream end of pressure chamber 40 in other embodiments. For example, assembly 30 may be enclosed in a casing (not shown), and the upstream surface of the casing may therefore form the downstream end of pressure chamber 40.

Pressure chamber 40 also includes a sidewall in the form of a flexible annular curtain 44 suspended from air cooling ring 42, which defines an outer surface of pressure chamber 40 (i.e. a boundary between the interior of pressure chamber 40 and the atmosphere). The inner surface of pressure chamber 40 is defined by the outer surface of bubble 20 (i.e. a boundary between the interior of pressure chamber 40 and the interior of bubble 20).

Thus, pressure chamber 40 defines a chamber volume, encompassing the space between the face of die head 16 and air cooling ring 42 (i.e. the upstream end wall), cooling assembly 30, curtain 44 (i.e. the side wall) and bubble 20. The sidewall (curtain 44, in the present example) is moveable between a closed position for restricting air flow from the above-mentioned chamber volume surrounding bubble 20 to the atmosphere, and an open position for permitting air flow from the chamber volume to the atmosphere. As will become apparent below, the chamber volume need not be entirely enclosed, but rather is enclosed (when curtain 44 is in the closed position) to a sufficient degree to develop a pressure differential between the chamber volume and the atmosphere outside pressure chamber 40.

When machine 10 is in use, bubble 20 is inflated internally by air (or any other suitable gas) supplied through a pipe 46. The flow rate of air through pipe 46 into bubble 20 (indicated by an arrow at the downstream end of pipe 46) is controlled by a valve 50 or any other suitable control mechanism (e.g.

modulation at the source of the air supply, not shown). The supply of air into bubble 20 can be controlled, for example by a controller 66, to maintain a pressure “P” within bubble 20. In some embodiments, a vent pipe 48 may be included, along with a corresponding flow control (not shown), to aid in controlling the pressure within bubble 20. In the present embodiment, the pressure P within bubble 20 is not set directly at controller 66, but is controlled by controller 66 to maintain a consistent bubble 20 size (e.g. diameter). That is, a target size for bubble 20 is set at controller 66 via operator input, and controller 66 varies the pressure P in response to measurements of the size of bubble 20 to maintain the size of bubble 20 at the target value. Controller 66 additionally receives control feedback in the form of pressure measurements from one or more pressure sensors (not shown) within bubble 20, and thus implements closed loop control of pressure within bubble 20 to maintain a consistent size for bubble 20. Additional pressure control mechanisms will be discussed below.

Air cooling ring 42 (which forms the upstream end wall of pressure chamber 40, along with the face of die head 16) includes an inlet connected to an air supply line 52, to receive air from an air supply (not shown) external to the chamber volume. The air supply can be the same air supply as is used to provide air into bubble 20, or a different air supply, and can be controlled via, for example, a valve 54. Air cooling ring 42 also includes an outlet in fluid communication with the inlet. The outlet is configured to direct air received via line 52 into the chamber volume, to pressurize the chamber volume when curtain 44 is in the closed position. In the present example, air cooling ring includes a plurality of outlets in the form of ports 56 and 58.

Air cooling ring 42 is illustrated as being hollow (that is, providing a single disc-shaped internal conduit between line 52 and outlets 56 and 58), but in other embodiments a plurality of internal conduits can be provided. The arrangement and shape of outlets 56 and 58 is not particularly limited. In the present example, outlets 56 and 58 are annular, extending substantially continuously around bubble 20. Outlet 56, in the present example, is adjacent to the outlet of die head 16, and air directed into pressure chamber 40 through outlet 56 (shown by straight arrows in FIG. 2) can serve not only to pressurize pressure chamber 40, but also to cool bubble 20 by being directed onto the outer surface of bubble 20 as bubble 20 exits die head 16.

The side wall of pressure chamber 40, in addition to curtain 44, includes an annular frame 62 mounted to the downstream end of curtain 44.

Connected to frame 62 are a plurality of adjustable vents 60, which allow varying degrees of restricted air to flow from the chamber volume to the atmosphere when curtain 44 is in the closed position (as shown by straight arrows between assembly 30 and vents 60). For example, vents 60 (either independently or in concert) can be adjusted upwards to provide a larger opening between frame 62 and assembly 30 (allowing more air to escape pressure chamber 40), or downwards to provide a smaller opening between frame 62 and assembly 30 (allowing less, or no, air to escape pressure chamber 40).

It will now be apparent to those skilled in the art that a pressure “P2” within the chamber volume (that is, the pressure within pressure chamber 40) can be controlled by controlling the air flow into air cooling ring 42, as well as the position of vents 60. An ultrasonic sensor 64 (or any other suitable range-finding sensor) can be provided within pressure chamber 40, for measuring the external diameter of bubble 20. More specifically, sensor 64 produces a signal indicating the distance from sensor 64 to the outer surface of bubble 20. Given the known position of sensor 64, controller 66 can derive the diameter of bubble 20 from the signal. Thus, the signal is not necessarily a direct measurement of bubble diameter, but is indicative of the diameter of bubble 20.

Controller 66 is configured, based on input signals received from sensor 64 and on any other suitable input parameters (e.g. a predetermined set point, or target, for bubble 20 diameter as mentioned earlier), to send control signals to control valves 50 and 54, as well as vents 60, to regulate P and P2. In general, controller 66 is configured to regulate P based on the previously mentioned target size for bubble 20 and the measured size of bubble 20 received from sensor 64 (as well as pressure measurements from within bubble 20). Controller 66 is also configured to regulate P2 based on control input, for example received from an operator or derived from other parameters such as a set flow rate at die head 16. That is, controller 66 can receive a target P2 or other associated parameter from which a target P2 can be derived, and controller 66 regulates P2 to maintain P2 at the target. As mentioned earlier, pressure sensors (not shown) are also installed within bubble 20 and within pressure chamber 40 to provide control feedback to controller 66. Thus, controller 66 may be configured to receive pressure measurements for P and P2, and can be configured to adjust vents 60 as well as air supply accordingly, implementing closed loop control of pressure within bubble 20 and pressure chamber 40.

Bubble 20 has a hoop strength, representing the resistance to outward expansion of bubble 20 provided by the molten polymer in bubble 20. It is therefore desirable to maintain a positive pressure within bubble 20 (relative to the outside environment of bubble 20), to overcome the hoop strength and expand bubble 20 to the desired diameter (established by assembly 30). The internal pressure (P) within bubble 20 is regulated by controller 66 to overcome the above-mentioned hoop strength, or melt strength, and maintain the target size for bubble 20. In other embodiments, control of pressure P can also optionally be based on the desired thickness of the film being produced.

When throughput at die head 16 is increased, controller 66 can be configured (e.g. via operator input or by deriving a new P2 from the new throughput) to increase the pressure P2 within pressure chamber 40. Increasing the pressure P2 can reduce the incidence of wrinkles in bubble 20 at collapsing frame 34. In addition, increasing the throughput at die head 16 may have the effect of reducing the hoop strength of the melt forming bubble 20, as the extrudate has less time to cool before being blown to form bubble 20 (hotter polymer may have reduced hoop strength).

As a result of the increased P2 and reduced hoop strength mentioned above, controller 66, through the previously described control of P within bubble 20, increases the pressure within pressure chamber 40 to maintain the size of bubble 20 at the target size. In other words, controller 66 responds to the change of pressure P2 by regulating the pressure P within bubble 20, to maintain bubble 20′s size. By setting the target size for bubble 20 and the pressure within pressure chamber 40, therefore, the size of bubble 20 can be maintained at the target, and the pressure within bubble 20 can be maintained at a sufficiently high level to reduce or eliminate wrinkles in bubble 20 when bubble 20 reaches collapsing frame 34.

As will be apparent from the discussion above, controller 66 will regulate P to be greater than P2 by varying degrees. The differential between P and P2 depends on the hoop strength of bubble 20. If P were to be greater than P2 by too large a margin, upsetting the balance between hoop strength and internal bubble pressure, bubble 20 may over-expand (conversely, bubble 20 may collapse if P is too small relative to P2).

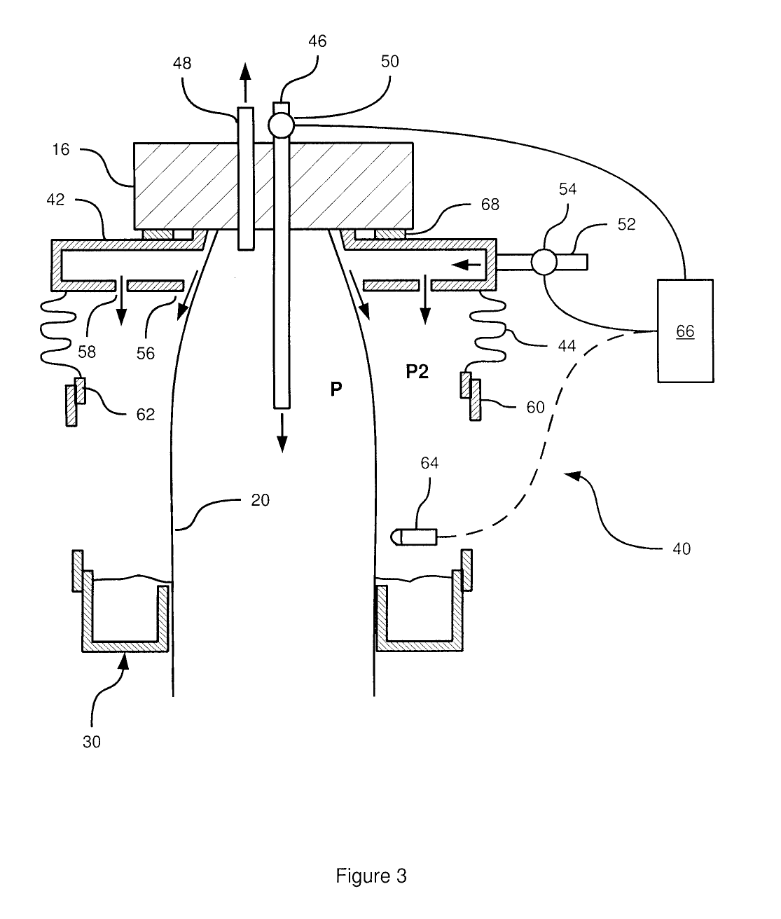

Turning now to FIG. 3, the embodiment shown in FIG. 2 is illustrated with curtain 44 in the open position. Curtain 44 is lifted into the open position by a lifting mechanism (not shown). For example, a lifting mechanism such as a cable connected to a winch or other motor may be employed to lift annular frame 62 in an upstream direction, retracting curtain 44 adjacent to air cooling ring 42.

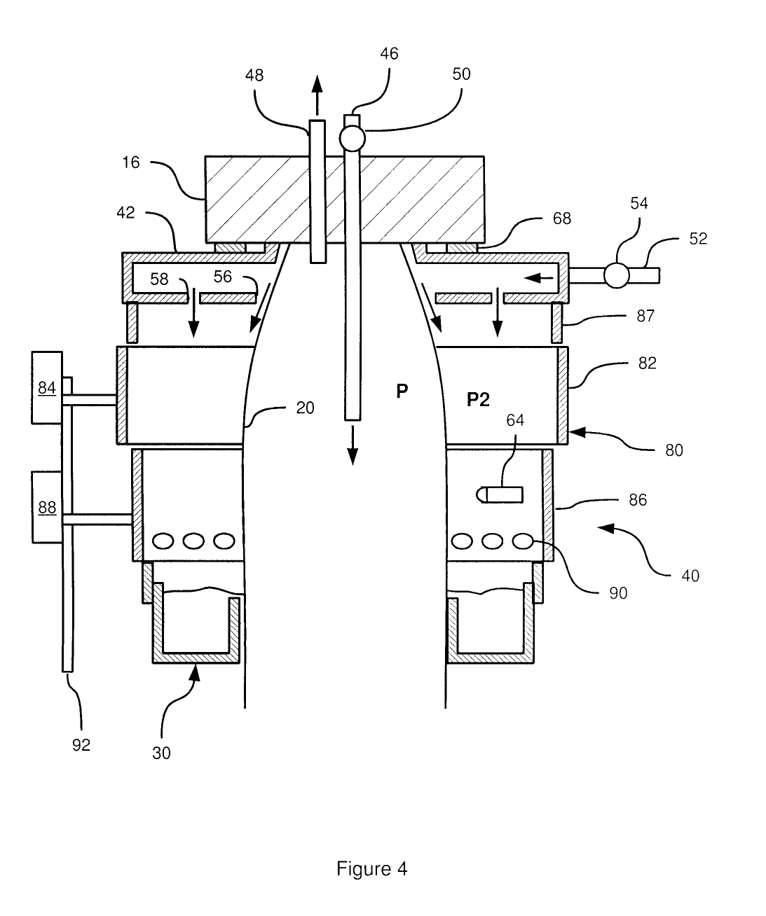

Turning now to FIG. 4, a presently preferred embodiment is illustrated. Where similarly-numbered components are illustrated in FIG. 4 as were discussed in connection with FIGS. 2 and 3, those components are as described above unless specifically discussed below. Controller 66 is omitted from FIG. 4 for simplicity of illustration, but can be included. Of note, in the embodiment shown in FIG. 4 the side wall of pressure chamber 40 is provided not by curtain 44 and frame 62, but by a telescoping wall assembly 80, including a plurality of moveable annular wall segments (which may also be referred to as wall sections).

The side wall of pressure chamber 40 as shown in FIG. 4 includes an upstream moveable wall segment 82, and a downstream moveable wall segment 86. Additional moveable wall segments (not shown) may be provided in other embodiments. Further, wall assembly 80 can include a fixed wall segment 87 mounted to air cooling ring 42. In other embodiments, fixed wall segment 87 can be omitted.

Each of moveable wall segments 82 and 86 has a raised position and a lowered position. Together, moveable wall segments 82 and 86 define a closed position for wall assembly 80 when both segments 82 and 86 are in their raised positions (as shown in FIG. 4). In the illustrated closed position, restricted air flow out to the atmosphere may be permitted through a gap between segments 82 and 86. In other embodiments, wall segments 82 and 86 may be provided with seals to prevent such air flow.

Wall segment 86 can include one or more vents 90, which can be adjustable to permit greater or lesser degrees of restricted air flow from pressure chamber 40 to the atmosphere. Wall segments 82 and 86 are moveable, in the present example, by way of respective motors 84 and 88 coupled to segments 82 and 86. Other lifting mechanisms may also be employed to move segments 82 and 86. Motors 84 and 88 may be mounted on a rail 92 or other supporting structure. For example, motors 84 and 88 may be fixed to wall segments 82 and 86, and may be operated to slide along rail 92, moving segments 82 and 86 upstream or downstream. In other embodiments, motors 84 and 86 can be fixed to rail 92, and can be operated to move segments 82 and 86 relative to motors 84 and 88.

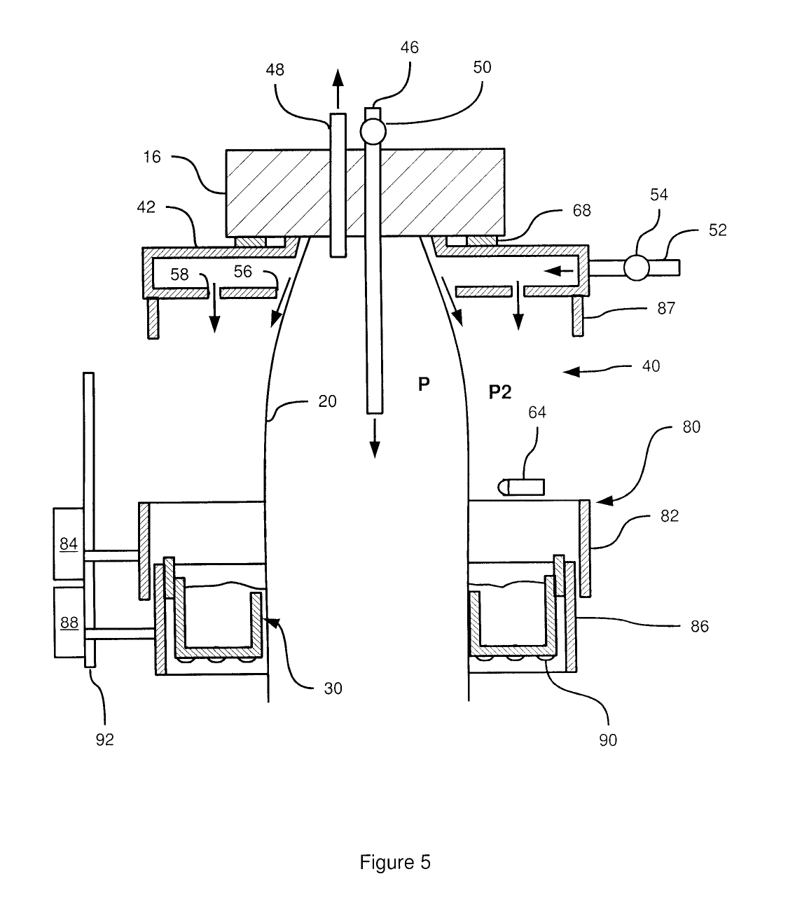

Referring to FIG. 5, the embodiment of FIG. 4 is shown with wall assembly in the open position. Motors 84 and 86 have been operated to slide down rail 92, moving segments 82 and 86 downstream and opening pressure chamber 40. In other embodiments, one or both of segments 82 and 86 may be moved upstream rather than downstream.

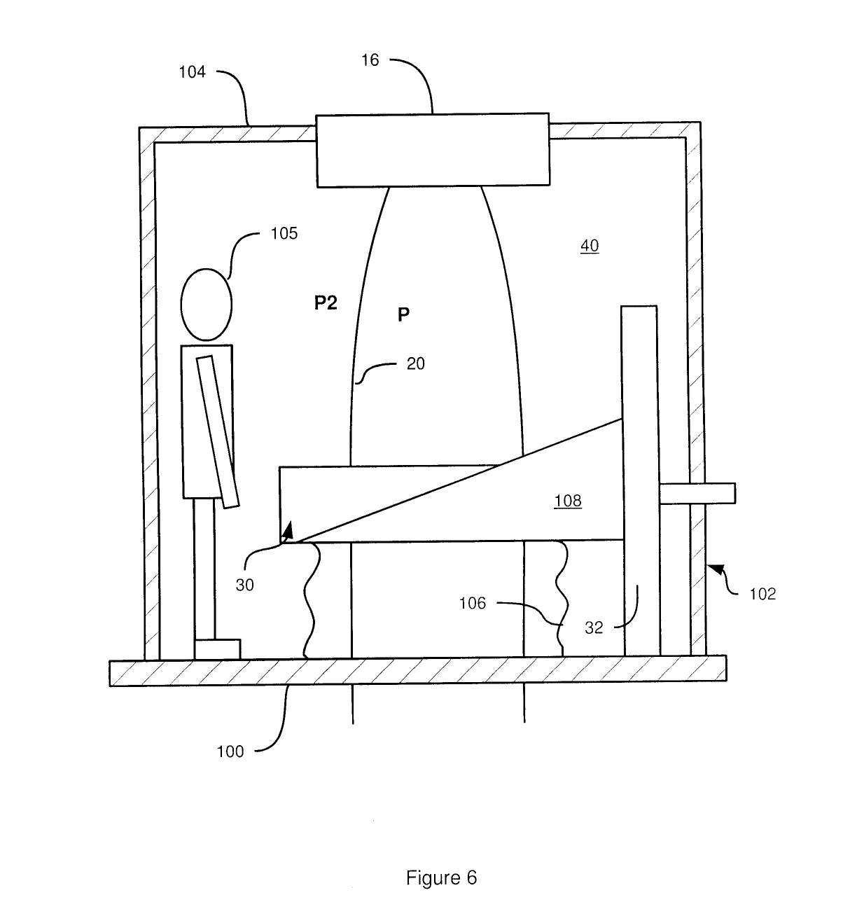

Referring now to FIG. 6, a partial cross section through an alternate embodiment is shown, in which pressure chamber 40 is defined by an enclosure 102 that extends between the die head 16 and a deck 100 beneath the vertically adjustable frame 32 that supports the cooling assembly 30. Enclosure 102 includes a roof 104 providing the upstream end wall of pressure chamber 40 (provided by air cooling ring 42 in previous embodiments), and side walls extending from roof 104 to deck 100.

Enclosure 102 is large enough to allow an operator 105 to enter enclosure 102 and move around cooling assembly 30 and thereby conveniently enable the start-up process for machine 10. The external sides of enclosure 102 can be made of a solid wall construction and include an air lock (with double doors, not shown) to provide access for operator 105 while air pressure within enclosure 102 is maintained. Deck 100 and roof 104 of enclosure 102 can also be made of solid construction. In other embodiments, however, a variety of materials and structures can be employed for deck 100, enclosure 102 and roof 104. For example, in some embodiments enclosure 102 may be constructed from a plastic or metal (or a combination thereof) frame over which is laid an impermeable film to prevent the escape of air from pressure chamber 40.

A flexible annular skirt 106 can be mounted between the downstream (e.g. lower) side of ring assembly 30 and deck 100, allowing ring assembly 30 to be moved vertically along adjustable frame 32 (e.g. by sliding a support member 108 along frame 32) while maintaining the ability for the interior of enclosure 102 to be pressurized with minimal losses. More specifically, the opening in deck 100 allowing bubble 20 to pass through deck 100 is generally not equipped to seal against bubble 20 (indeed, such sealing may not be desirable). Thus, in the absence of skirt 106, air may escape between bubble 20 and deck 100. Alternatively flexible annular skirt 106 could be mounted between the downstream side of any annular seal surrounding the bubble that is downstream of the frost line of the bubble during operation.

The side walls of enclosure 102 also include adjustable vents (not shown) to exhaust hot air from pressure chamber 40. The control of P and P2 is accomplished by a controller, via the control of air supply into bubble 20, air supply into pressure chamber 40 (for example, via a mechanism similar to air cooling ring 42 as described above, not shown in FIG. 6), and if applicable, adjustment of exit vents in pressure chamber 40, as discussed above.

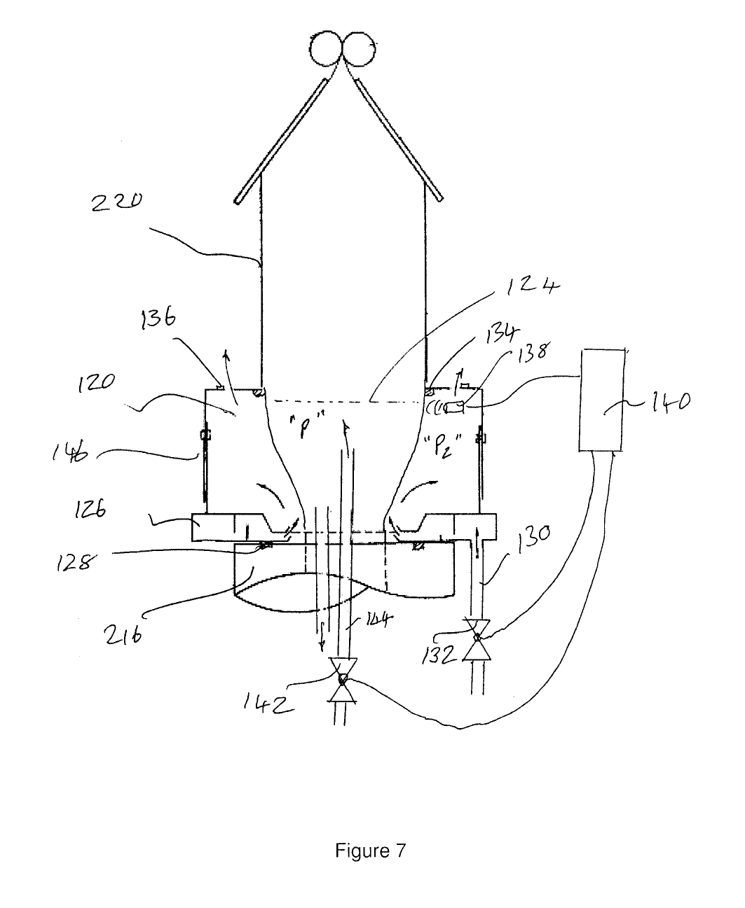

Turning now to FIG. 7, a partial cross section through another alternate embodiment is shown. FIG. 7 illustrates a blown film extrusion line having an upward path rather than the downward path discussed earlier herein. A pressure chamber 120 is provided that surrounds a bubble 220 between a die head 216 and a position downstream (i.e. above) of a frost line 124 on bubble 220. The frost line is defined by a cooling mechanism (not shown), which may be cooling air directed at the outer surface of bubble 220.

Air is supplied via an inlet port 144 and a control valve 142 or other regulator, to inflate bubble 220. An air cooling ring assembly 126 sealed from die head 216 by a seal 128 (e.g. an annular seal such as an O-ring or a weld) is used to distribute air to the interior of pressure chamber 120 from a supply line 130. Air flow through line 130 is controlled by a valve 132 or any other suitable control mechanism. Ring assembly 126, in other words, is similar to air cooling ring 42 discussed above.

An annular sealing ring 134, which in some embodiments can be an expandable sealing ring as described in Applicant's U.S. provisional application No. 61/987827, filed May 2, 2014, surrounds bubble 220 downstream of frost line 124 and thus forms the downstream end of pressure chamber 120. In some embodiments, annular sealing ring 134 may be omitted, and instead air may be allowed to exit pressure chamber 120 travelling alongside bubble 20. The size of the gap that replaces seal 134 determines the velocity of air exiting pressure chamber 120, which can aid in cooling bubble 20. Adjustable vents 136 in the top (i.e. the downstream end) of pressure chamber 120 control the amount of air escaping from pressure chamber 120. An ultrasonic sensor 138 can be provided to within pressure chamber 120 to measure the size of bubble 220. Signals from sensor 138 are used by a controller 140 to control valves 132 and 142 (as well as vents 136 in some embodiments).

As described above in connection with controller 66, controller 140 is configured to regulate a pressure within bubble 220 (“P”) in order to maintain the size of bubble 20 at a predetermined target value. Controller 66 is also configured to regulate P2 based on control inputs such as a direct setting of P2 or a throughput rate at die head 16. The result of such control is that P is maintained at a level greater than the pressure within pressure chamber 120 (“P2”), with the differential between P and P2 varying with the hoop strength of bubble 20.

Pressure chamber 120 can have a side wall defined by telescoping wall segments 146 to allow vertical adjustment so that seal 134 can be positioned downstream of frost line 124 for a variety of processing conditions and bubble configurations. Seal 134 has the capability of changing its internal diameter in order to conform to a variety of bubble diameters and processing conditions.

Certain advantages to the embodiments described herein will occur to those skilled in the art. For example, the incorporation of a pressure chamber in a blown film extrusion line can provide a larger operating window, allowing increased throughput and improved film quality.

The scope of the claims should not be limited by the embodiments set forth in the above examples, but should be given the broadest interpretation consistent with the description as a whole.

1. A pressure chamber for a blown film extrusion apparatus having (i) a die head for extruding a tubular polymer bubble from a die head outlet, and (ii) a cooling assembly downstream of the die head for receiving the bubble and applying a cooling fluid to an outer surface of the bubble, the pressure chamber comprising:
an upstream end wall sealed to the die head around the die head outlet, the upstream end wall extending outward from a seal;
a side wall movable between a closed position for controlling air flow from a chamber volume surrounding the bubble to the atmosphere, and an open position for permitting air flow from the chamber volume to the atmosphere;
the upstream end wall having an inlet configured to receive air from an air supply external to the chamber volume, and an outlet in fluid communication with the inlet and configured to direct the air into the chamber volume to pressurize the chamber volume when the side wall is in the closed position.

2. The pressure chamber of claim 1, the upstream end wall comprising a disk containing a conduit between the inlet and the outlet.

3. The pressure chamber of claim 1, the seal comprising an annular seal disposed between the upstream end wall and the die head.

4. The pressure chamber of claim 3, the annular seal comprising an O-ring.

5. The pressure chamber of claim 3, the annular seal comprising a weld.

6. The pressure chamber of claim 1, the outlet of the upstream end wall comprising an annular outlet adjacent to the die head outlet, configured to direct air into the chamber volume and onto the outer surface of the bubble exiting the die head outlet.

7. The pressure chamber of claim 1, the side wall comprising a flexible curtain suspended from a perimeter of the upstream end wall;
the flexible curtain extending from the upstream end wall to the cooling assembly in the closed position, and retracted adjacent to the upstream end wall in the open position.

8. The pressure chamber of claim 7, the side wall further comprising a frame connected to a downstream end of the flexible curtain; the frame having an adjustable vent configured to admit restricted airflow from the chamber volume to the atmosphere when the flexible curtain is in the closed position.

9. The pressure chamber of claim 7, further comprising a lifting mechanism for retracting the flexible curtain towards the upstream end wall.

10. The pressure chamber of claim 9, wherein the lifting mechanism comprises a cable.

11. The pressure chamber of claim 1, the side wall comprising a plurality of moveable annular segments.

12. The pressure chamber of claim 11, the plurality of moveable annular segments configured to telescope into the closed position adjacent the cooling assembly.

13. The pressure chamber of claim 12, further comprising:
a lifting mechanism coupled to each of the plurality of moveable segments.

14. The pressure chamber of claim 13, wherein each said lifting mechanism comprises a motor mechanically coupled to a corresponding one of the moveable segments.

15. The pressure chamber of claim 1, at least one of the moveable segments having an adjustable vent configured to admit restricted airflow from the chamber volume to the atmosphere when the plurality of moveable segments are in the closed position.

16. The pressure chamber of claim 1, further comprising:
a sensor within the chamber volume, configured to generate a sensor signal indicative of a diameter of the bubble.

17. The pressure chamber of claim 16, the sensor comprising an ultrasonic sensor.

18. The pressure chamber of claim 16, further comprising:
a controller connected to the sensor; the controller configured to receive the sensor signal and, in response, generate and transmit a control signal to the air supply to control air pressure within the chamber volume.

19. The pressure chamber of claim 18, the controller further configured to transmit a second control signal to control an air pressure within the bubble.

20. A process for blown film extrusion, comprising:
extruding, from a die head, a tubular bubble of polymer film;
at a controller:
receiving a sensor signal from a sensor disposed between the die head and a cooling assembly downstream of the die head, the signal indicative of a diameter of the bubble;
generating a control signal based on the sensor signal; and
transmitting the control signal to an air supply connected to a pressure chamber enclosing the bubble between the die head and the cooling assembly, to control air pressure within the pressure chamber.
